(19) United States
(12) Patent Application Publication
(10) Pub. No.: US 2019/0122245 A1
(43) Pub. Date: Apr. 25, 2019

(54) SYSTEMS AND METHODS FOR DISPLAYING AN ORDER DISCOUNT ON A USER INTERFACE

(71) Applicant: Walmart Apollo, LLC, Bentonville, AR (US)

(72) Inventors: Kartikay Sahay, Foster City, CA (US); Sarabjeet Singh, San Francisco, CA (US); Yang Tang, Redwood City, CA (US); Stephen Samuel Menaquale, South San Francisco, CA (US); Vikrant Tare, Dublin, CA (US); Karan Jain, Sunnyvale, CA (US); Kritarth Upadhyay, San Jose, CA (US); Sindiri Sai Kumar, Bengaluru (IN); Puneet Kala, Bengaluru (IN)

(73) Assignee: Walmart Apollo, LLC, Bentonville, AR (US)

(21) Appl. No.: 16/165,999

(22) Filed: Oct. 19, 2018

Related U.S. Application Data
(60) Provisional application No. 62/574,672, filed on Oct. 19, 2017.

(51) Int. Cl. G06Q 30/02; G06Q 30/06; G06Q 10/08

(52) U.S. Cl. CPC G06Q 30/0222; G06Q 30/0641; G06Q 10/08345; G06Q 30/0635

(57) ABSTRACT

Systems and methods including one or more processing modules and one or more non-transitory storage modules storing computing instructions configured to run on the one or more processing modules and perform acts of coordinating displaying a set of items of an online retailer on a user interface of a customer electronic device of a customer; receiving, from the customer electronic device, a first selection by the customer of a first item of the set of items to place the first item in an electronic shopping cart of the customer for a customer order; determining a first shipping cost to the online retailer for a first delivery of the first item to the customer by a first date from a first shipping location; determining a second shipping cost to the online retailer for the first delivery of the first item to the customer by a second date from the first shipping location, the second date occurring after the first date and the second shipping cost being less than the first shipping cost; determining a first order discount for the first item.

### CROSS REFERENCE TO RELATED APPLICATIONS

This application claims the benefit of U.S. Provisional Application No. 62/574,672, which is herein incorporated by reference in its entirety.

### TECHNICAL FIELD

This disclosure relates generally to displaying various order discounts on a user interface of a customer electronic device.

### BACKGROUND

Many customers of retailers now utilize the Internet to shop for items available for purchase from a retailer. In some instances, users can visit the website or mobile application of an online retailer to order one or more items and have the one or more items delivered to the customer. Some retailers offer free shipping within a certain time period according to a service level agreement for (1) an order that meets a predetermined monetary amount, and/or (2) any orders, if the customer is a paid subscriber to the retailer. While free shipping can be beneficial to customers, not all customers need an item delivered in the time specified in the service level agreement for free or discounted shipping. For example, some customer orders may qualify for free two-day shipping, but a customer may not need the order for seven days. Thus, orders can be shipped unnecessarily fast to the customer from the retailer, resulting in unnecessary costs. Further, these types of tradeoffs of a later delivery date for savings on shipping costs should be displayed to the customer in a way that efficiently and effectively conveys information to the customer.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 is a flowchart for a method, according to certain embodiments;

FIG. 5 illustrates a representative block diagram of a portion of the system of FIG. 3, according to an embodiment; and

FIGS. 6A-K illustrate views of a user interface, according to embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform an act of coordinating displaying a set of items of an online retailer on a user interface of a customer electronic device of a customer; receiving, from the customer electronic device, a first selection by the customer of a first item of the set of items to place the first item in an electronic shopping cart of the customer for a customer order; determining a first shipping cost to the online retailer for a first delivery of the first item to the customer by a first date from a first shipping location; determining a second shipping cost to the online retailer for the first delivery of the first item to the customer by a second date from the first shipping location, the second date occurring after the first date and the second shipping cost being less than the first shipping cost; determining a first order discount for the first item, wherein (1) the first order discount is based at least partially on a difference between the first shipping cost and the second shipping cost, and (2) the first order discount is applied to a first final cost of the first item in the customer order when the customer selects the second date for the first delivery of the first item; coordinating displaying a checkout page on the user interface of the customer electronic device, wherein the checkout page can comprise (1) a first delivery date option, wherein the first delivery date option can comprise the first date for the first delivery of the first item to the customer, (2) a second delivery date option, wherein the second delivery date option can comprise the second date for the first delivery of the first item to the customer, (3) the first order discount that is applied to the first final cost of the first item in the customer order when the customer selects the second delivery date option, and (4) the first order discount that is not applied to the first final cost of the first item in the customer order when the customer selects the first delivery date option, wherein the first final cost does not include the first shipping cost or the second shipping cost; when the customer selects the second delivery date option, applying the first order discount to the first final cost of the first item when the customer completes the customer order; and when the customer selects the first delivery date option, not applying the first order discount to the final cost of the first item when the customer completes the customer order.

Various embodiments include a method. The method can include coordinating displaying a set of items of an online retailer on a user interface of a customer electronic device of a customer; receiving, from the customer electronic device, a first selection by the customer of a first item of the set of items to place the first item in an electronic shopping cart of the customer for a customer order; determining a first shipping cost to the online retailer for a first delivery of the first item to the customer by a first date from a first shipping location; determining a second shipping cost to the online retailer for the first delivery of the first item to the customer by a second date from the first shipping location, the second date occurring after the first date and the second shipping cost being less than the first shipping cost; determining a first order discount for the first item, wherein (1) the first order discount is based at least partially on a difference between the first shipping cost and the second shipping cost, and (2) the first order discount is applied to a first final cost of the first item in the customer order when the customer selects the second date for the first delivery of the first item; coordinating displaying a checkout page on the user interface of the customer electronic device, wherein the checkout page can comprise (1) a first delivery date option, wherein the first delivery date option can comprise the first date for the first delivery of the first item to the customer, (2) a second delivery date option, wherein the second delivery date option can comprise the second date for the first delivery of the first item to the customer, (3) the first order discount that is applied to the first final cost of the first item in the customer order when the customer selects the second delivery date option, and (4) the first order discount that is not applied to the first final cost of the first item in the customer order when the customer selects the first delivery date option, wherein the first final cost does not include the first shipping cost or the second shipping cost; when the customer selects the second delivery date option, applying the first order discount to the first final cost of the first item when the customer completes the customer order; and when the customer selects the first delivery date option, not applying the first order discount to the final cost of the first item when the customer completes the customer order.

A number of embodiments can include a system. The system can include one or more processing modules and one or more non-transitory storage modules storing computing instructions configured to run on the one or more processing modules. The one or more storage modules can be configured to run on the one or more processing modules and perform acts of displaying, on a user interface of a customer electronic device of a customer, a set of items of an online retailer; displaying, on the user interface of the customer electronic device, an electronic shopping cart, wherein the electronic shopping cart can comprise at least a first item of the set of items and the first item being selected by the customer in a first selection of a customer order; displaying, on the user interface of the customer electronic device, a first delivery date option on a checkout page, wherein the first delivery date option can comprise a first date for a first delivery of the first item; displaying, on the user interface of the customer electronic device, a second delivery date option on the checkout page, wherein the second delivery option can comprise a second date for the first delivery of the first item, the second date occurring after the first date; and displaying, on the user interface of the customer electronic device, a first order discount on the checkout page proximate the second delivery date option displayed on the user interface, wherein: the first order discount is applied to a first final cost of the first item in the customer order when the customer selects the second delivery date option; the first order discount is not applied to the first final cost of the first item in the customer order when the customer selects the first delivery date option, wherein the first final cost does not include the first shipping cost or the second shipping cost; and the first order discount is based at least partially on a difference between (1) a first shipping cost to the online retailer for the first delivery of the first item to the customer by the first date from a first shipping location, and (2) the second shipping cost to the online retailer for the first delivery of the first item to the customer by the second date from the first shipping location, the second date being after the first date.

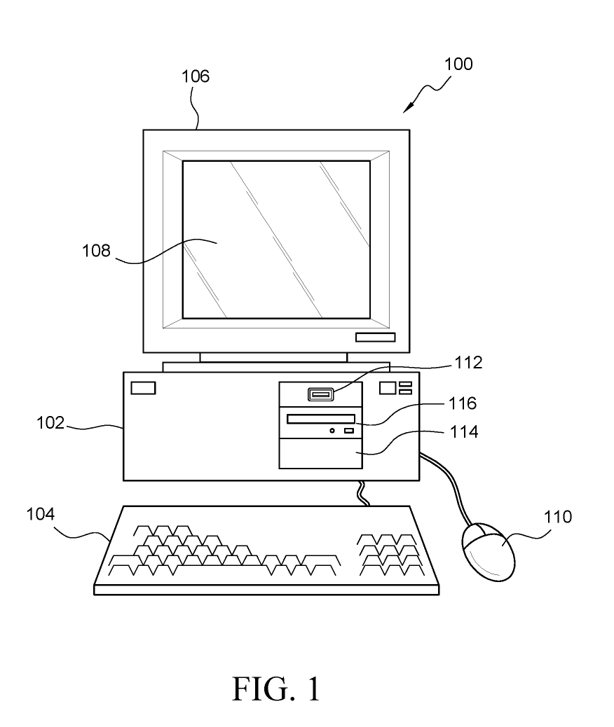

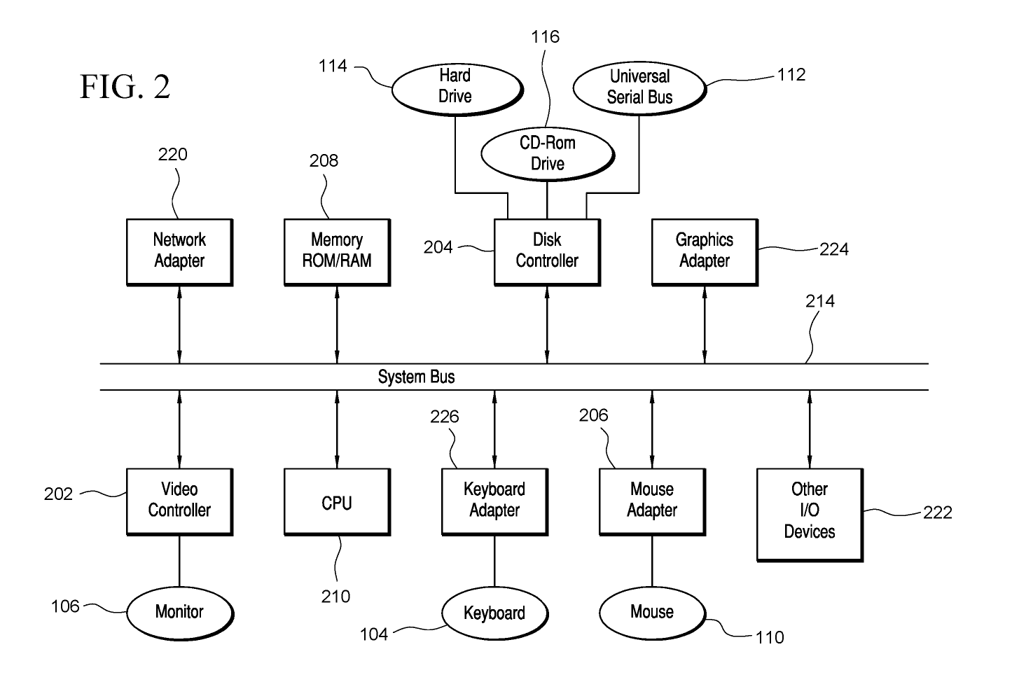

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory.

Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

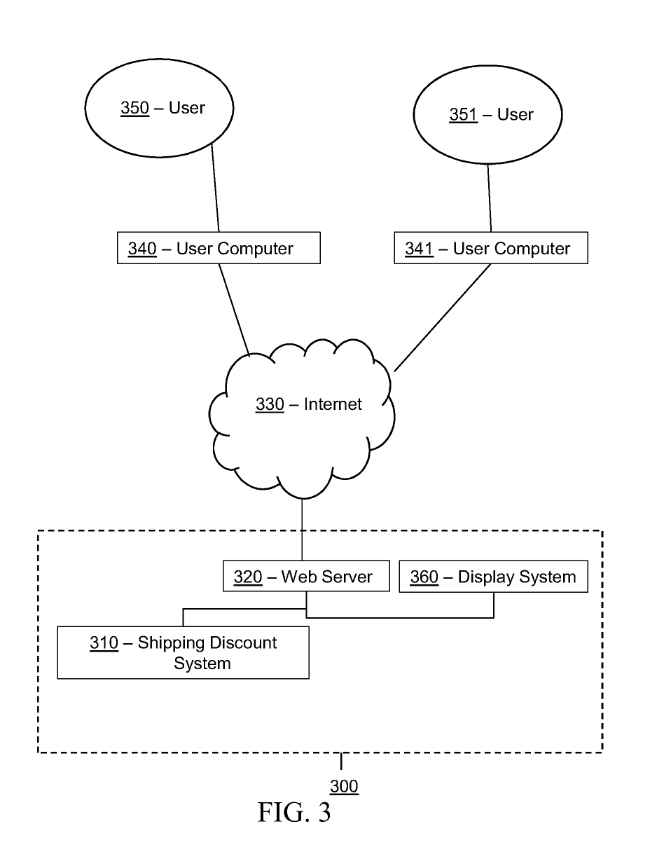

Turning ahead in the drawings, FIG. 3 illustrates a block diagram of a system 300 that can be employed for displaying an order discount on a user interface, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a shipping discount system 310, a web server 320, and a display system 360. Shipping discount system 310, web server 320, and/or display system 360 can each be a computer system, such as computer system 100 (FIG. 1), as described above, and can each be a single computer, a single server, or a cluster or collection of computers or servers, or a cloud of computers or servers. In another embodiment, a single computer system can host each of two or more of shipping discount system 310, web server 320, and/or display system 360. Additional details regarding shipping discount system 310, web server 320, and display system 360 are described herein.

In many embodiments, system 300 also can comprise user computers 340, 341. User computers 340, 341 can comprise any of the elements described in relation to computer system 100. In some embodiments, user computers 340, 341 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, shipping discount system 310, web server 320, and/or display system 360 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) shipping discount system 310, web server 320, and/or display system 360 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of shipping discount system 310, web server 320, and/or display system 360. In a similar manner, the processing module(s) and the memory storage module(s) can be local and/or remote to each other.

In many embodiments, shipping discount system 310, web server 320, and/or display system 360 can be configured to communicate with one or more user computers 340 and 341. In some embodiments, user computers 340 and 341 also can be referred to as customer computers. In some embodiments, shipping discount system 310, web server 320, and/or display system 360 can communicate or interface (e.g., interact) with one or more customer computers (such as user computers 340 and 341) through a network or internet 330. Internet 330 can be an intranet that is not open to the public. Accordingly, in many embodiments, shipping discount system 310, web server 320, and/or display system 360 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers or customer electronic devices. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, shipping discount system 310, web server 320, and/or display system 360 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between shipping discount system 310, web server 320, and/or display system 360, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

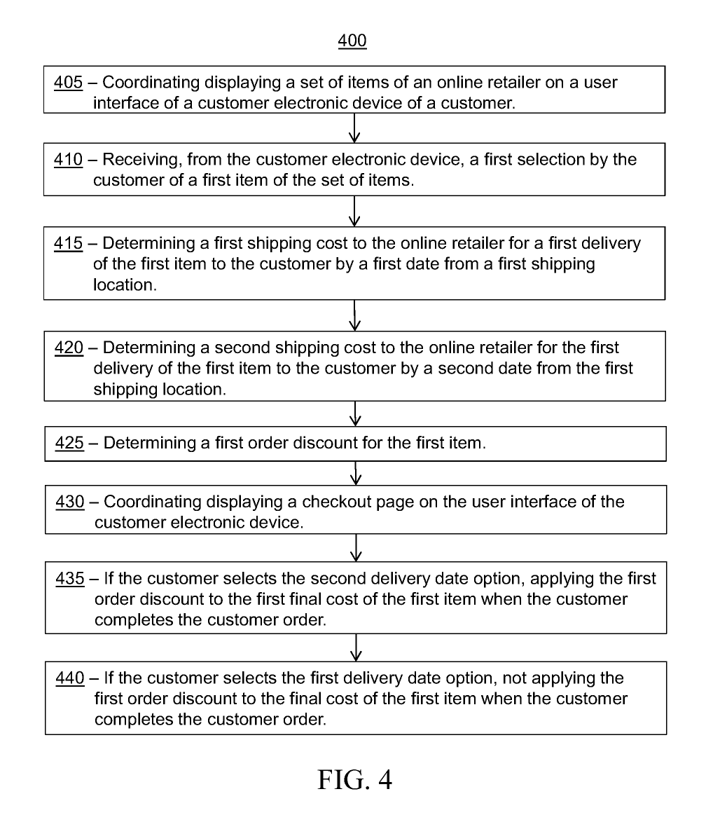

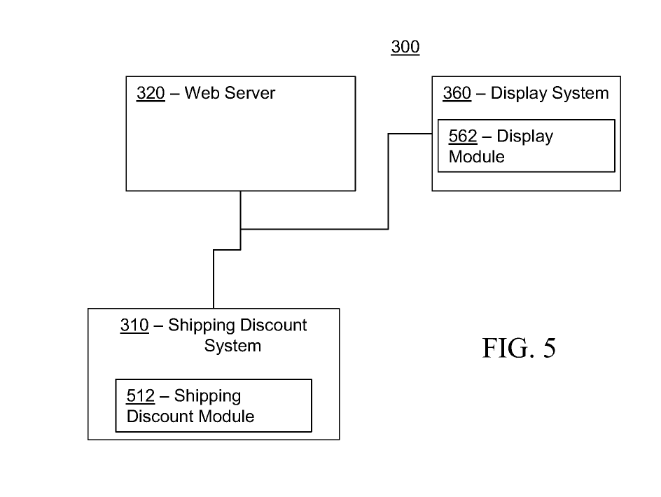

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512 and/or 562 (FIG. 5). Such non-transitory memory storage modules can be part of a computer system such as shipping discount system 310, web server 320, and/or display system 360 (FIGS. 3 & 5). The processing module(s) can be similar or identical to the processing module(s) described above with respect to computer system 100 (FIG. 1).

Many customers of retailers now utilize the Internet to shop for items available for purchase from the retailer. In some instances, users can visit the website or mobile application of an online retailer to order one or more items and have the one or more items delivered to the customer. Some retailers offer free shipping within a certain time period according to a service level agreement (SLA) for (1) an order that meets a predetermined monetary amount, and/or (2) any orders, if the customer is a paid subscriber to the retailer. While free shipping can be beneficial to customers, not all customers need an item delivered in the time specified in the SLA for free or discounted shipping. For example, some customer orders may qualify for free two-day shipping, but a customer may not need the order for seven days. Thus, orders can be shipped unnecessarily fast to the customer from the retailer, resulting in unnecessary costs. To solve this problem, various embodiments of method 400 and related systems determine and display, on user interfaces, order discounts that are available to a customer if the customer selects a slower shipping speed than the free shipping available to the customer as part of a SLA.

In many embodiments, method 400 can comprise an activity 405 of coordinating displaying a set of items of an online retailer on a user interface of a customer electronic device of a customer. Activity 405 also can comprise generating instructions for providing a user interface on an electronic device of a user that displays a set of items of an online retailer. The online retailer can comprise a retailer that is exclusively online, or also can comprise a retailer that associated with both an ecommerce website and a brick and mortar store. The set of items can comprise any of a number of different products, SKUs, and the like made available for purchase by the online retailer. One or more of the items in the set of items can be available exclusively for shipping to the customer from a distribution center, warehouse, fulfillment center, or brick and mortar store. One or more of the items in the set of items can be available for either (1) shipping to the customer from a distribution center, warehouse, fulfillment center, or brick and mortar store, or (2) pickup at by the customer at a distribution center, warehouse, fulfillment center, or brick and mortar store.

In many embodiments, the customer electronic device can comprise any embodiments of user computer 340, described above. For example, the customer electronic device can comprise a mobile smart phone, a desktop computer, a tablet computer, a smart watch, and so on. The user interface can comprise an interface displayed on the screen of the customer electronic device. For example, the user interface can be displayed on the customer electronic device as part of a webpage, website, software application, mobile application, and so on.

In some embodiments, activity 405 and other activities in method 400 can comprise using a distributed network comprising distributed memory architecture to perform the associated activity. This distributed architecture can reduce the impact on the network and system resources to reduce congestion in bottlenecks while still allowing data to be accessible from a central location.

In many embodiments, method 400 can comprise an activity 410 of receiving, from the customer electronic device, at least one selection by the customer of at least one item of the set of items. For example, activity 410 can comprise receiving, from the customer electronic device a first selection by the customer of a first item of the set of items. In many embodiments, a customer can make multiple selections of items in an order. Thus, activity 410 of method 400 can optionally comprise an additional activity receiving, from the user interface of the customer electronic device, a second selection and/or an additional selection by the customer of a second item of the set of items and/or an additional item of the set of items.

When one or more selections of one or more items are made by the customer, the one or more items can be placed in an electronic shopping cart by system 300 (FIG. 3). Thus, activity 410 can further comprise an additional activity of placing the first item, the second item, and/or the additional item (as referenced above) in an electronic shopping cart of the customer for a customer order. In many embodiments, activity 410 can further comprise an optional activity of displaying, on the user interface of the customer electronic device, the electronic shopping cart. The electronic shopping cart displayed on the user interface can comprise the items placed in the electronic shopping cart by system 300 (FIG. 3) when a customer selected the items. For example, the electronic shopping cart can display a first item, a second item, and/or an additional item of the set of items as selected by the customer.

In many embodiments, once one or more items are placed in an electronic shopping cart, system 300 (FIG) can determine if the order qualifies for any order discounts. For example, some embodiments can optionally require (1) the electronic shopping cost, including at least one item eligible for free two-day shipping as part of a SLA, and/or (2) the total value of the one or more items in the electronic shopping cart exceed a predetermined value. Thus, method 400 also can optionally comprise an activity of determining if the order is eligible for an order discount.

Once one or more items are placed in an electronic shopping cart, system 300 (FIG. 3) can determine various shipping costs to the online retailer for delivering the one or more items to a customer. The various shipping costs can depend on the expected delivery date of the one or more items. For example, two-day shipping for an item can cost the online retailer $7.50, while five-day shipping for the same item (and sometimes from the same location) can cost the online retailer only $5.50. Thus, in many embodiments, method 400 can comprise an activity of determining a shipping cost to the online retailer for a delivery of one or more items of the order to the customer within a time frame required by the SLA. For example, the SLA can require the online retailer to provide free or discounted two-day shipping if the order exceeds a predetermined monetary threshold and/or the customer is a subscriber to the online retailer. In some embodiments, a delivery date can comprise a pick-up date. In various embodiments, a pick-up date can comprise a date when an item is available to be picked up from a brick and mortar store.

In many embodiments, method 400 can comprise an activity 415 of determining a first shipping cost to the online retailer for a delivery of the item to the customer by a first date from a first shipping location. Here, the first delivery of the item to the customer by the first date can be the free or discounted shipping promised to the customer as part of the SLA. When multiple items are in the electronic shopping cart, activity 415 can further comprise an activity of determining a first shipping cost to the online retailer for each item of the multiple items in the cart to be delivered within the time frame of the SLA, even if the items are shipping from different locations and/or are grouped in different groups based on shipping options. First shipping costs to the online retailer for delivery each item of the multiple items in the electronic shopping cart within the time frame of the SLA can be different depending on the item, the location from which the item is shipping, and/or the shipping speed. Moreover, dates of delivery to meet the SLA can be different for different items in the electronic shopping cart.

System 300 (FIG. 3) also can determine shipping costs to the online retailer for shipping one or more items of an order slower than the requirements of the SLA. For example, system 300 (FIG. 3) can determine a shipping cost to the online retailer for delivering an item of the customer order with five-day shipping rather than the two-day shipping of the SLA. Many times, the shipping cost to the online retailer for delivering the item(s) of the order at a later date beyond the requirements of the SLA is cheaper than the shipping cost to the online retailer for delivery the item(s) of the order on or before an earlier date required by the SLA.

In many embodiments, method 400 can comprise an activity 420 of determining a second shipping cost to the online retailer for the delivery of the item to the customer by a second date from the first shipping location, the second date occurring after the first date and the second shipping cost being less than the first shipping cost. When multiple items are in the electronic shopping cart, activity 420 can further comprise an activity of determining a second shipping cost to the online retailer for each item of the multiple items in the cart to be delivered to the customer in a time frame beyond the SLA, even if the items are shipping from different locations and/or are grouped in different groups based on shipping options. Second shipping costs to the online retailer for delivery of each item of the multiple items in the cart in a time frame beyond the SLA can be different depending on the item, the location from which the item is shipping, and/or the shipping speed.

In some embodiments, multiple items in an order can be grouped into one or more groups based on when each item can be delivered to the customer. In some circumstances, items must be ordered by a certain time of day to qualify for delivery of the item within two business days. In other circumstances, shipping origination locations and/or shipping destination locations can make delivery of an item impractical within the two-day shipping of the SLA. For example, if an order is placed on a Monday evening, two items in an order can be available for delivery to the customer by Wednesday for a two-day shipping date, while a third item in the same order can be available for a delivery to the customer by Thursday for a two-day shipping date. In this non-limiting example, the first and second items that can be delivered on Wednesday can be grouped into a first group, while the additional item(s) that cannot be delivered until Thursday is grouped into a second group.

In some optional embodiments, then, method 400 can comprise an activity of grouping the items of an order into one or more groups. The activity of grouping the items of an order into one or more groups can comprise (1) grouping at least one item into a first group of items based on the at least one item being available for delivery on a first SLA date, and (2) grouping at least one additional item into an additional group of at least one item based on the at least one additional item being available for delivery on a second SLA date but not available for delivery on the first SLA date.

With the shipping cost to meet the SLA and the slower shipping cost calculated for each item, system 300 (FIG. 3) can determine a shipping discount. As shall be described in greater detail below, shipping discounts can be according to each item, each group, and/or some combination thereof.

Continuing in FIG. 4, in many embodiments, method 400 can comprise an activity 425 of determining a first order discount for the each item in an order. The order discount is in addition to the free or otherwise discounted shipping that can be a part of the SLA between the customer and the online retailer. While calculations are described in relation to the first shipping cost and the second shipping cost for an item, similar or identical calculations can be made for each item of an order. In many embodiments, the first order discount can be based at least partially on a difference between the first shipping cost to the online retailer for delivery of the item by a first date and the second shipping cost to the online retailer for delivery of the item by a second date that is after the first date. Moreover, in many embodiments, the first order discount can be applied to a final cost of the item in the customer order if the customer selects the second date for the delivery of the item despite being entitled to receive the item by the first date.

In many embodiments, activity 425 can comprise multiple activities for determining the order discount for the item. For example, activity 425 can first comprise determining a difference between the first shipping cost to the online retailer for delivery of the item by a first date and the second shipping cost to the online retailer for delivery of the item by a second date that is after the first date. In some embodiments, an order discount is determined for each shipment, including a shipment comprising multiple items. For example, a first order discount can be determined for a first shipment that includes two items of the order and is shipped from a first location, and a second order discount can be determined for a second shipment that includes only one item of the same order and is shipped from a second location. As shall be described in detail below, order discounts for multiple shipments can be combined to create a group order discount. For example, the first order discount and the second order discount just referenced can be combined to create a first group discount for an order, while an additional group of items in an order may or may not qualify for an additional group order discount.

By way of a non-limiting example, a customer can select item1 and item2 for placement in an electronic shopping cart for a customer order. System 300 (FIG. 3) can determine that (1) the shipping cost to the online retailer for shipping item1 and item2 from a single, first location for a 2-day delivery (first) date is $7.50, and (2) the shipping cost to the online retailer for shipping item1 and item2 from the single first location for a 5-day delivery (second) date is $5.50. The difference in cost to the online retailer between delivering item1 and item2 by the first date and the second date is, then, $2.00.

In many embodiments, activity 425 can further comprise an additional activity of multiplying (1) the difference between the first shipping cost and the second shipping cost by (2) a predetermined percentage to determine a shipping savings for the item. For example, in the example described above, the difference in cost to the online retailer between delivering item1 and item2 by the first date and the second date is $2.00. This $2.00 difference can then be multiplied a predetermined percentage to determine a shipping savings for item1 and item2. In one example, the predetermined percentage can be 80%. In this example, then, $2.00 is multiplied by 80%, resulting in a shipping savings of $1.60. The predetermined percentage that is multiplied by the difference in between the first shipping cost and the second shipping cost can vary or be changed based on various factors. For example, during certain times of the year, the online retailer may prefer that more customers select a later delivery date, and thus the online retailer may have a higher predetermined percentage than when the online retailer prefers that fewer customers select a slower shipping date despite being entitled to the faster shipping date.

In many embodiments, activity 425 can further comprise an additional activity of determining if the shipping savings for the item exceeds a minimum shipping discount. The online retailer can, in some embodiments, set a minimum shipping discount to be offered to each customer to select a later delivery date. Returning to the example above, an online retailer can select a minimum shipping discount of $0.50 to be offered to for an item and/or group of items in an order. System 300 (FIG. 3) can then determine that the shipping savings of $1.60 is greater than the minimum shipping discount of $0.50. The minimum shipping discount can vary or be changed based on various factors. For example, during certain times of the year and/or based on the distribution center from which the shipment will be made, the online retailer may prefer that more customers select a later delivery date, despite being entitled to the faster shipping date, and thus the online retailer may have a higher minimum shipping discount than when the online retailer prefers that fewer customers select a later shipping date. In some embodiments, the minimum shipping discount can be referred to as a capacity discount floor, and the maximum of the capacity discount floor and the shipping savings can be selected for the order discount. Thus, if the calculated shipping discount for selecting the slower shipping date is less than the minimum shipping discount, then the actual shipping discount can be automatically increased to the minimum shipping discount.

In many embodiments, activity 425 can further comprise an additional activity of determining if the shipping savings for the first item do not exceed a maximum shipping discount per shipment. Returning to the example above, an online retailer can select a maximum shipping discount of $5.00 to be offered for an item and/or group of items in a shipment of an order. System 300 (FIG. 3) can then determine that the shipping savings of $1.60 is less than the maximum shipping discount of $5.00. The maximum shipping discount can vary or be changed based on various factors. For example, during certain times of the year, and/or based on the distribution center from which the shipment will be made, the online retailer may prefer that more customers select a later delivery date, despite being entitled to the earlier shipping date, and thus the online retailer may have a higher maximum shipping discount than when the online retailer prefers that fewer customers select a later shipping date. In some embodiments, the maximum shipping discount can be referred to as a discount ceiling, and the minimum of the discount ceiling and the shipping savings can be selected for the order discount.

In many embodiments, activity 425 can further comprise an additional activity of determining if the shipping savings is less than a total price of the first item multiplied by an additional predetermined percentage. For example, in some embodiments, an order discount can be capped at a maximum of a percentage of the retail value or price of the item(s) in a shipment. Returning to the example above, the total retail value of item1 and item2 is $35, and this total retail value of $35 can be multiplied by an additional predetermined percentage of 10% to obtain a maximum savings of $3.50 for the products. System 300 can then determine that the shipping savings of $1.60 is less than the product savings of $3.50. The additional predetermined percentage can vary or be changed based on various factors. For example, during certain times of the year, and/or based on the distribution center from which the shipment will be made, the online retailer may prefer that more customers select a later delivery date, despite being entitled to the earlier shipping date, and thus the online retailer may have a higher additional predetermined percentage than when the online retailer prefers that fewer customers select a later shipping date. In some embodiments, the minimum of (1) the additional predetermined percentage multiplied by the retail value of the shipment and (2) the shipping savings can be selected for the order discount. Thus, if the calculated shipping discount for selecting the later shipping date is greater than the additional predetermined percentage multiplied by the retail value of the shipment, then the actual shipping discount can be automatically decreased to the additional predetermined percentage multiplied by the retail value of the shipment.

In many embodiments, activity 425 can further comprise an additional activity of determining if the shipping savings is less than a brick and mortar store pickup discount. For example, in some embodiments, system 300 (FIG. 3) can determine that item1 and item2 are available for customer pickup at a brick and mortar store within a predetermined proximity to the customer. If item1 and/or item2 are available for customer pickup at a brick and mortar store within a predetermined proximity to the customer, then a brick and mortar store pickup discount can be offered to the customer. System 300 (FIG. 3) can determine if the calculated shipping savings is less than a brick and mortar store pickup discount of $5 for item1 and/or item2.

In many embodiments, activity 425 can further comprise an additional activity of rounding the shipping savings to a nearest predetermined value. For example, in some embodiments, the shipping savings can be rounded to the nearest $0.25. Returning to the example above, the shipping savings can be rounded to $1.50.

In many embodiments, activity 425 can comprise an additional activity of using the shipping savings as the order discount if (1) the calculated shipping savings for the item exceeds the minimum shipping discount, (2) the calculated shipping savings do not exceed the maximum shipping discount, and (3) the calculated shipping savings is less than each of (a) the total price of the item multiplied by the additional predetermined percentage, and (b) the brick and mortar store pickup discount.

As noted above, activity 425 can be applied to multiple items in an order. For example, system 300 (FIG. 3) can determine that item1 and item2 in an electronic shopping cart can be shipped in a single shipment from Los Angeles for delivery by a first date, and item3 in the electronic shopping cart can be shipped in a shipment from Dallas for delivery by the first date. Activity 425 of determining an order discount can then be applied to item3, as described above for item1 and item2, with perhaps a different result (i.e., the final discount amount might be different even if the retail shipment value for item 3 is the same as the retail shipment value for item1 and item2. That is, an order discount can be determined for item3. Like the order for item1 and item2, the order discount for item3 is based at least partially on a difference between the shipping cost for the first date and the shipping cost for the second. The order discount for item3 can be applied to a final cost of item3 in the customer order if the customer selects the second shipping date for the delivery of the item3, despite being entitled to the first or earlier shipping date.

In some embodiments, order discounts can be determined for each group of items grouped as described above. Activity 425, then, can comprise an additional activity of determining a first group order discount by adding the order discounts for each shipment grouped in the first group of items. Returning to the example above, the order discount for item1 and item2 can be determined to be $1.50, and the order discount for item3 can be determined to be $2.25. If item1, item2, and item3 are grouped together because item1, item2, and item3 can be delivered to the customer by the same 2-day delivery date or by the same 5-day delivery date despite being shipped in different shipments from two or more different locations, item1, item2, and item3 are grouped together in a single group. The order discount of $1.50 for item1 and item2 can then be added to the order discount of $2.25 for item3 to obtain a group order discount of $3.75.

If an order in the electronic shopping cart is determined to include a first group of items and an additional group of at least one item, an additional order discount also can be determined for the additional item in the additional group. The additional order discount can be determined as described above. For example, the additional order discount can be based at least partially on a difference between the shipping cost for delivering the additional item by an earlier date and the shipping cost for delivering the additional item by a later shipping date. The additional order discount can be applied to an additional final cost of the additional item in the customer order if the customer selects the later shipping date for the additional delivery of the additional item despite being entitled to the earlier shipping date.

In some embodiments, if an order discount is determined based on multiple items being in a single shipment or grouped together, method 400 can comprise an activity of determining a pro-rated portion of the order discount for each of the first item and the second item. Returning to the example above, item1 had a retailer value of $20, item2 had a retail value of $15, and the shipping savings was $1.50. The pro-rated portion for the order discount for item1, then, is [(20/35)*1.5], or approximately $0.86. The pro-rated portion for the order discount for item2, then, is [(15/35)*1.5], or approximately $0.64. The pro-rated portions can be stored for use if the customer returns only one of the items. For example, if the customer returned only item1, then the customer would be reimbursed ($20−$0.86), or $19.14, rather than the full $20. Pro-rated portions of multiple items in a group of two different shipments can be determined in a similar manner using the group order discount. When the customer places the order and is notified about the shipping discount, the customer also can be notified that the shipping discount will be subtracted from the product value for determining the refund price if the customer returns the product.

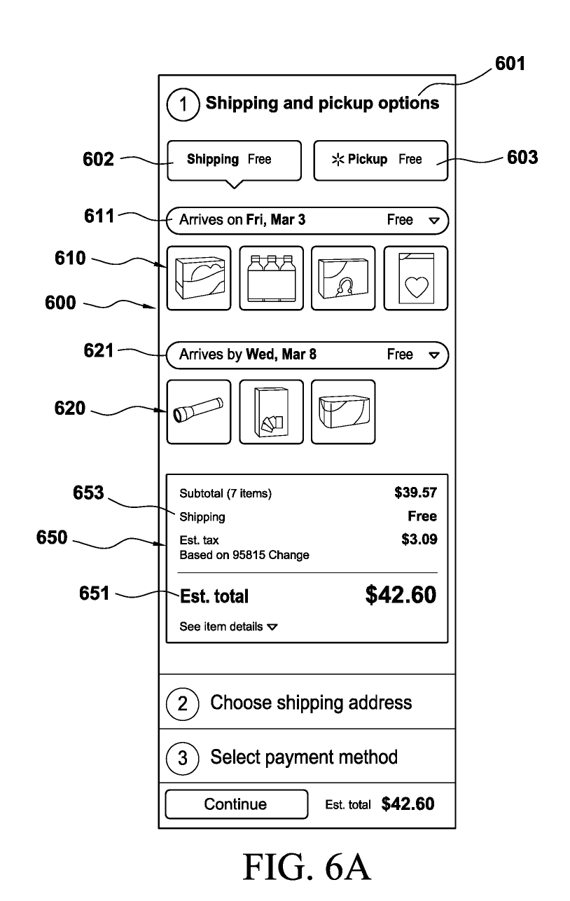

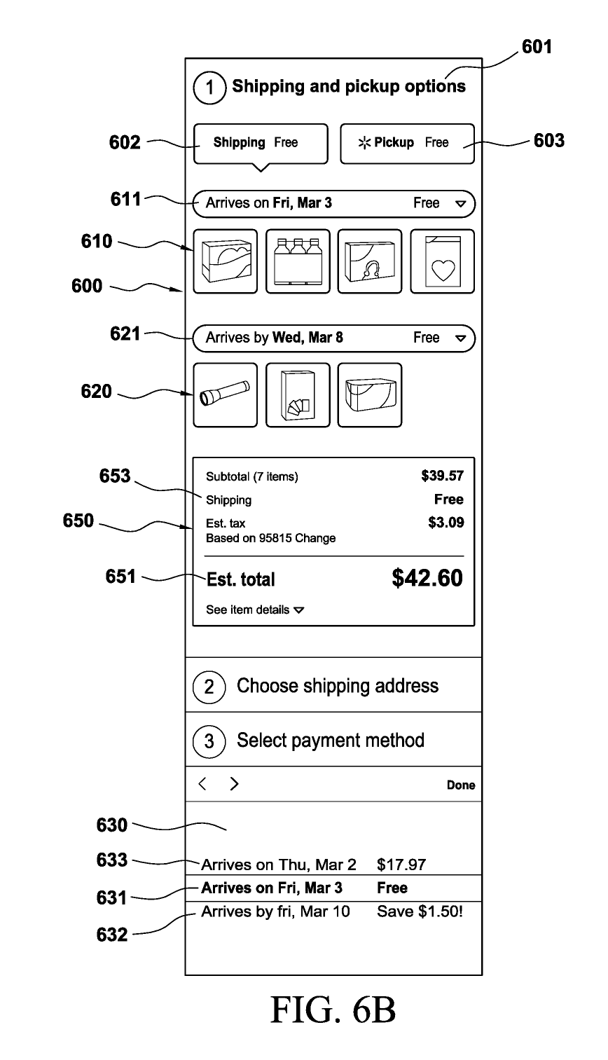

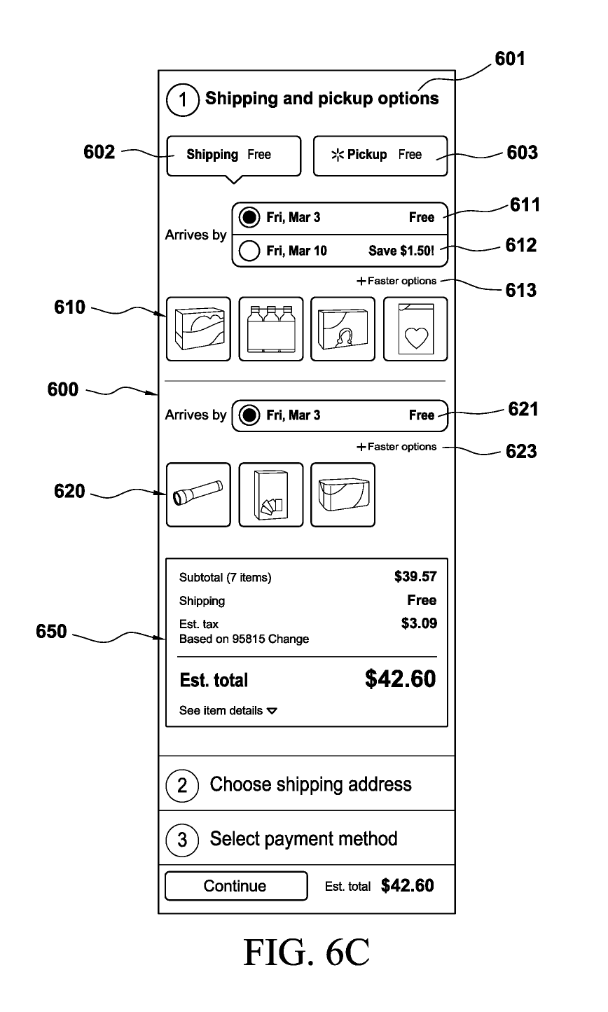

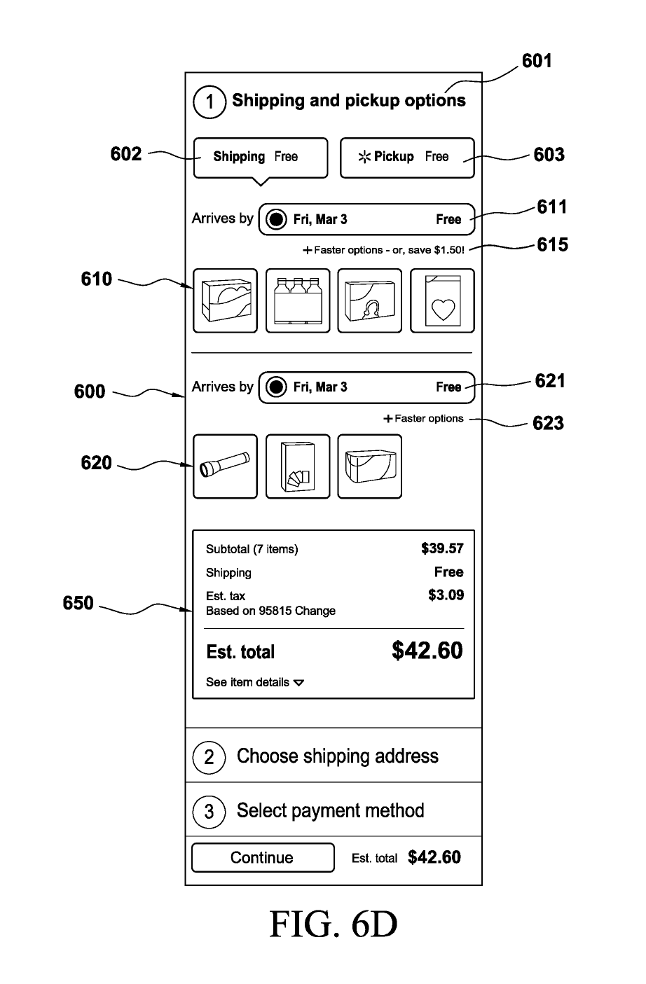

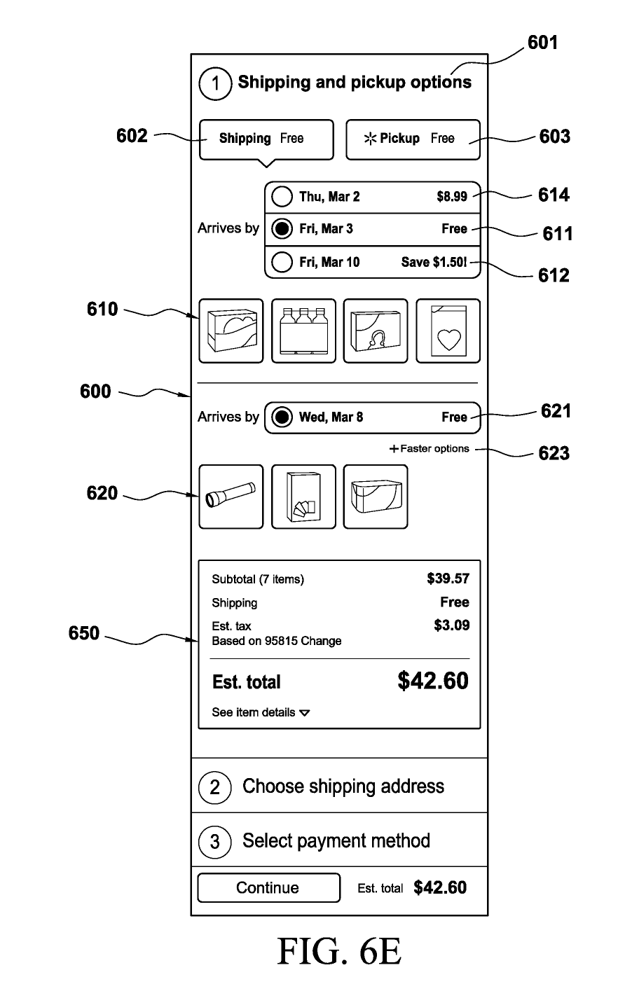

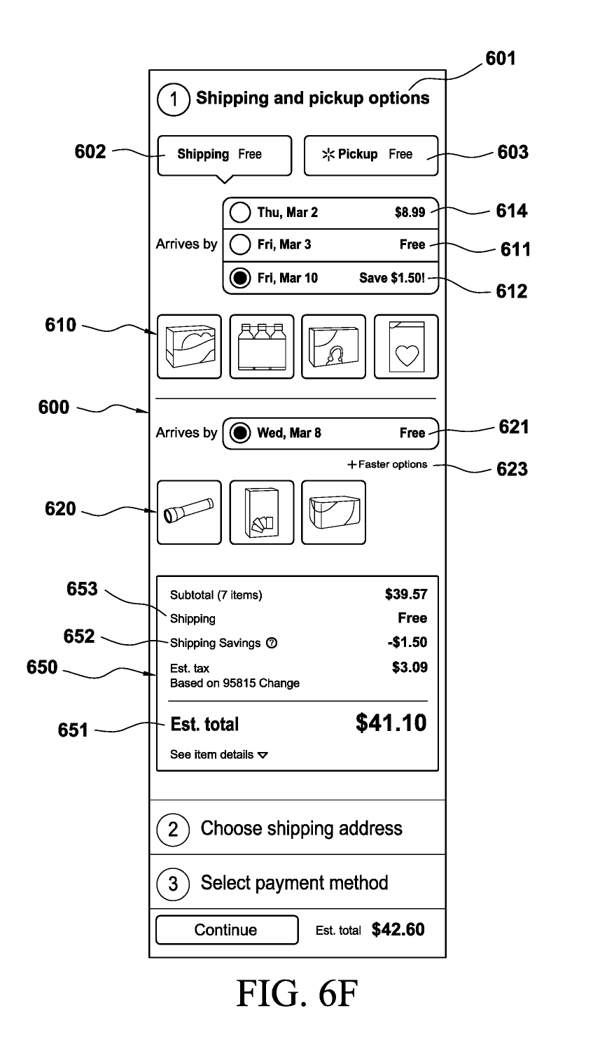

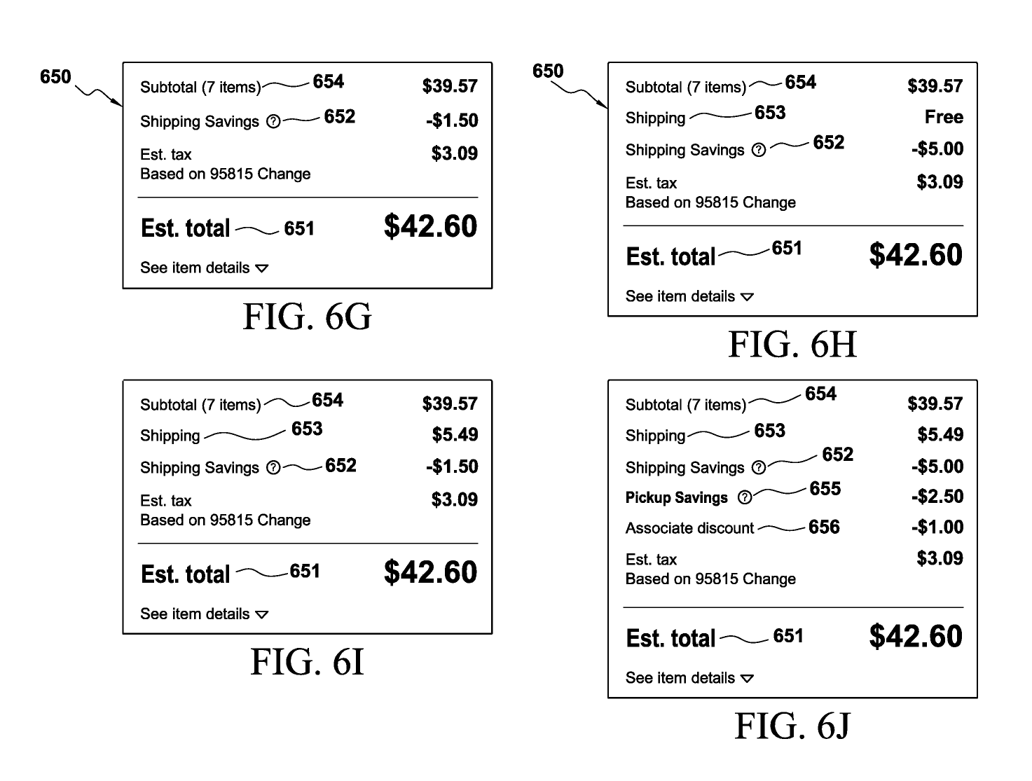

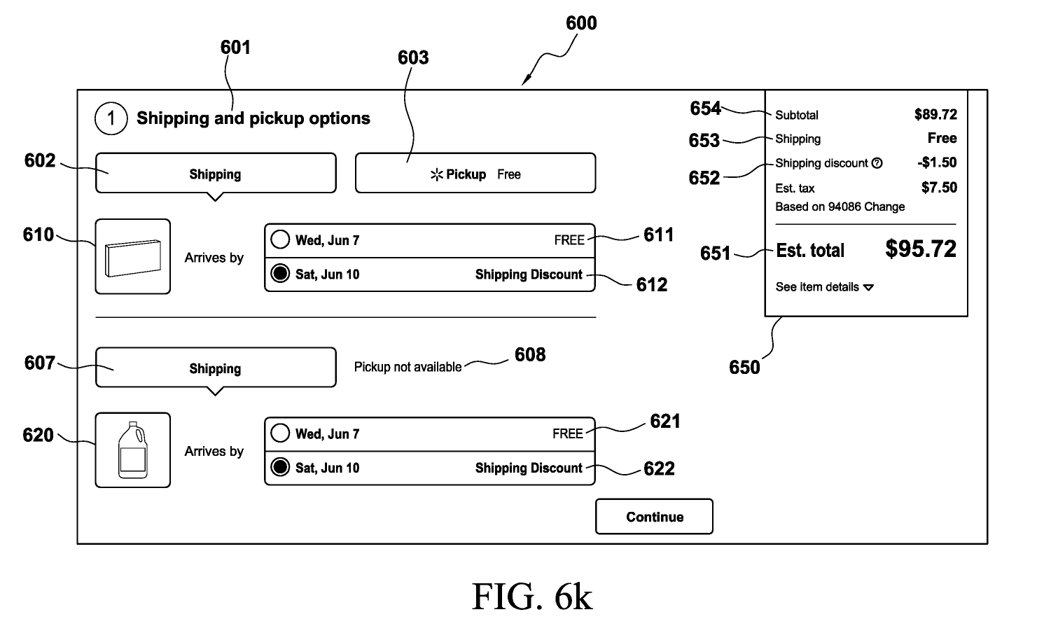

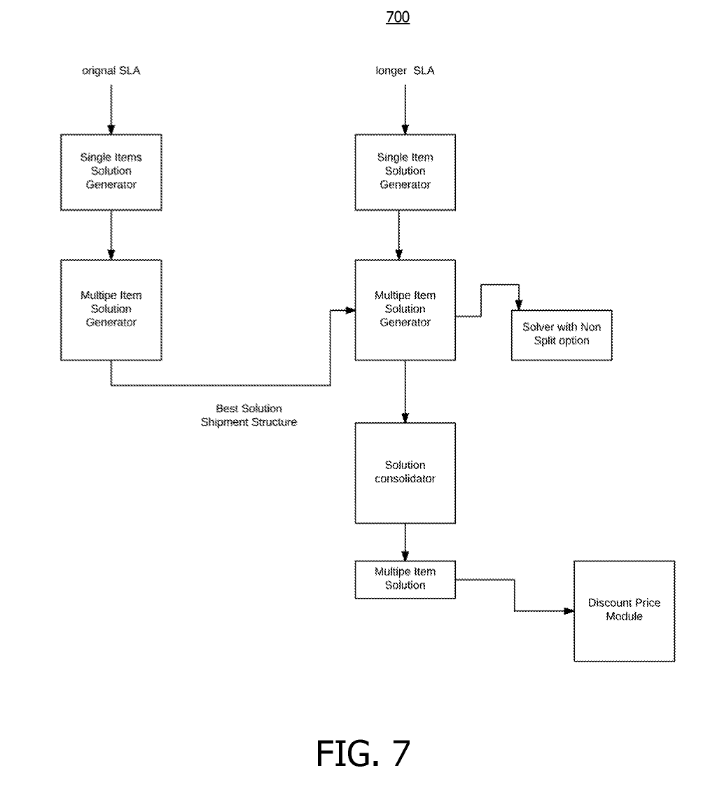

In many embodiments, method 400 can comprise an activity 430 of coordinating displaying a checkout page on the user interface of the customer electronic device. In the same or different embodiments, a checkout page can comprise one or more of the user interfaces described in FIGS. 6A-K. In some embodiments, the checkout page can comprise a “Proceed to Checkout” page that precedes a final checkout page. Activity 430 also can comprise generating instructions for providing a user interface on an electronic device of a user that displays a checkout page. The checkout page can comprise the various delivery dates for one or more items of an order, and any order discounts available to a customer if the customer selects a later delivery date for any of the one or more items of the order. For example, in some embodiments, the checkout page can comprise (1) a first delivery date option comprising the first date for the delivery of the item to the customer, (2) a second delivery date option comprising the second date for the delivery of the item to the customer, (3) the order discount that is applied to the final cost of the item in the customer order if the customer selects the second delivery date option, and (4) the order discount that is not applied to the final cost of the item in the customer order if the customer selects the first delivery date option. Returning to the example above, if item1 and item2 are not grouped with any other items, the checkout page can display (1) a first delivery date option comprising the first date of Wednesday for the delivery of item1 and item2 to the customer in a single shipment, (2) a second delivery date option comprising the second date of Friday for the delivery of item1 and item2 to the customer, and (3) the first order discount of $1.50 that is applied to the final cost of item1 and item2 in the customer order if the customer selects the second delivery date option of Friday.

In some embodiments, activity 430 can comprise coordinating displaying a dropdown shipping menu on the checkout page on the user interface of the customer electronic device. The dropdown shipping menu can comprise (1) the first delivery date option comprising the first date for the delivery of the item(s) to the customer and a first customer shipping cost (which could be $0.00) proximate the first delivery date option displayed on the user interface, (2) the second (or later) delivery date option comprising the second date for the delivery of the item to the customer and a same customer shipping cost proximate the first delivery date option displayed on the user interface, and (3) the order discount proximate the second delivery date option displayed on the user interface.

In some embodiments, the checkout page can comprise a discount icon. If the customer selects the discount icon, activity 430 can further comprise coordinating displaying (a) the second delivery date option comprising the second (or later) date for the delivery of the item to the customer, and (b) the order discount that is applied to the final cost of the item in the customer order if the customer selects the second delivery date option comprising the second (or later) date for the delivery of the item to the customer.

In some embodiments, the checkout page can comprise, if the customer selects the second delivery date option, an order cost box. The order cost box can comprise at least a subtotal cost of the item in the customer order, the customer shipping cost for the item, the order discount, and an estimated total of the subtotal cost added to the customer shipping cost, less the order discount.

In embodiments where items of two different shipments in an order are grouped together in a first group of items, the checkout page can comprise: (1) the first delivery date option comprising the first date for (a) the first delivery of the first item(s) (in a first shipment) to the customer and also (b) the second delivery of the second item(s) (in a second shipment) to the customer; (2) the second (or later) delivery date option comprising the second date for (a) the first delivery of the first item(s) to the customer and also (b) the second delivery of the second item(s) to the customer; (3) the first group discount that is applied to (a) the first final cost of the first item(s) in the customer order if the customer selects the second delivery date option comprising the second date for the first delivery of the first item(s) and (b) the second final cost of the second item(s) in the customer order if the customer selects the second delivery date option; and/or (4) the first group discount that is not applied to (a) the first final cost of the first item(s) in the customer order if the customer selects the first delivery date option comprising the first date for the first delivery of the first item(s) and (b) the second final cost of the second item(s) in the customer order if the customer selects the first delivery date option.

In embodiments where items of two different shipments in an order are grouped together the checkout page can further comprise the first item and the second item as grouped in the first group of items with (1) the first delivery date option comprising the first date, (2) the second (or later) delivery date option comprising the second date, and (3) the first group order discount that is applied to the first group if the customer selects the second delivery date option.

In embodiments where items in an order are grouped into two different groups of the first group (described above) of items and an additional group of at least one item, the checkout page can further comprise: (1) an additional first delivery date option comprising the earlier date for the additional delivery of the additional item to the customer; (2) an additional second (or later) delivery date option comprising the later date for the additional delivery of the additional item to the customer; (3) the additional order discount that is applied to the additional final cost of the additional item in the customer order if the customer selects the additional second delivery date option; and/or (4) the additional order discount that is not applied to the additional final cost of the additional item in the customer order if the customer selects the additional first delivery date option.

In embodiments where items in an order are grouped into two different groups of the first group (described above) and an additional group, the checkout page can further comprise the additional item as grouped in the additional group of at least one item with (1) the additional first delivery date option comprising the earlier date for the additional delivery of the additional item to the customer, (2) the additional second delivery date option comprising the later date for the additional delivery of the additional item to the customer, (3) the additional order discount that is applied to the additional final cost of the additional item in the customer order if the customer selects the additional second delivery date option, and/or (4) the additional order discount that is not applied to the additional final cost of the additional item in the customer order if the customer selects the additional first delivery date option.

In many embodiments, method 400 can comprise an activity 435 of, if the customer selects the second (or later) delivery date option that is beyond the time frame of the SLA, applying the order discount to the final cost of the item when the customer completes the customer order. If multiple items are in an order, activity 435 can further comprise, if the customer selects the second (or later) delivery date option, applying the second order discount to the second final cost of the second item when the customer completes the customer order. If multiple groups are in an order, activity 435 can further comprise, if the customer selects the additional second delivery date option for the additional delivery of the additional item of an additional group, applying the additional order discount to the additional final cost of the additional item in the additional group when the customer completes the customer order. In many embodiments, a customer can select a second (or later) delivery date option for a first group of items in the order, and also select a first (or SLA) delivery date option a second group of items in the order.

In many embodiments, method 400 can comprise an activity 440 of, if the customer selects the first (or earlier) delivery date option, not applying the order discount to the final cost of the item when the customer completes the customer order. If a second item is in an order, activity 440 can comprise, if the customer selects the first (or earlier) delivery date option, not applying the second order discount to the second final cost of the second item when the customer completes the customer order. If multiple groups are in an order, activity 435 can further comprise, if the customer selects the additional first delivery date option for the additional group, not applying the additional order discount to the additional final cost of the additional item in the additional group when the customer completes the customer order.

FIG. 5 illustrates a block diagram of a portion of system 300 comprising shipping discount system 310, web server 320, and display system 360, according to the embodiment shown in FIG. 3. Each of shipping discount system 310, web server 320, and/or display system 360 is merely exemplary and not limited to the embodiments presented herein. Each of shipping discount system 310, web server 320, and/or display system 360 can be employed in many different embodiments or examples not specifically depicted or described herein. In some embodiments, certain elements or modules of shipping discount system 310, web server 320, and/or display system 360 can perform various procedures, processes, and/or acts. In other embodiments, the procedures, processes, and/or acts can be performed by other suitable elements or modules.

In many embodiments, shipping discount system 310 can comprise non-transitory memory storage module 512. Memory storage module 512 can be referred to as shipping discount module 512. In many embodiments, shipping discount module 512 can store computing instructions configured to run on one or more processing modules and perform one or more acts of method 400 (FIG. 4) (e.g., activity 410 of receiving, from the customer electronic device, a first selection by the customer of a first item of the set of items, activity 415 of determining a first shipping cost to the online retailer for a first delivery of the first item to the customer by a first date from a first shipping location, activity 420 of determining a second shipping cost to the online retailer for the first delivery of the first item to the customer by a second date from the first shipping location, activity 425 of determining a first order discount for the first item, activity 435 of if the customer selects the second delivery date option, applying the first order discount to the first final cost of the first item when the customer completes the customer order, and activity 440 of if the customer selects the first delivery date option, not applying the first order discount to the final cost of the first item when the customer completes the customer order (FIG. 4)).

In many embodiments, display system 360 can comprise non-transitory memory storage module 562. Memory storage module 562 can be referred to as display module 562. In many embodiments, display module 562 can store computing instructions configured to run on one or more processing modules and perform one or more acts of method 400 (FIG. 4) (e.g., activity 405 of coordinating displaying a set of items of an online retailer on a user interface of a customer electronic device of a customer, and activity 430 of coordinating displaying a checkout page on the user interface of the customer electronic device (FIG. 4)).

Given the multitude of additional shipping options and discount data described above, a problem arises in that many customers can suffer from information overload, which then results in the loss of conversions as customers drop out of the transaction close to or at the last stage of the transaction. Further, customers may become confused by the additional discounts for a delayed delivery date, and not elect to have products delivered by that later delivery date. These problems can be made worse on mobile devices due to their smaller screens and limited area to display important information. A solution to these problems is to reduce the cognitive load on the user by designing a user interface which, in some embodiments, progressively or sequentially discloses information to the user as it becomes relevant and/or as it is requested by the user.

Turning ahead in the drawings, FIGS. 6A-K illustrate various examples of a user interface 600 that can be coordinated for display, by system 300 (FIG. 3), on a screen of user computer 340 (FIG. 3). Although not shown in FIGS. 6A-K, system 300 (FIG. 3) also can coordinate displaying, on a screen of user computer 340 (FIG. 3), user interface 600 with a set of items for user selection and/or an electronic shopping cart comprising at least one item selected by the customer from the set of items.

Referring specifically to FIG. 6A, in many embodiments, interface 600 can display a checkout page 601. Checkout page 601 can comprise a shipping icon 602 and/or a pickup icon 603. In some embodiments, system 300 (FIG. 3) can determine that one or more items of an order are available for either shipping to the customer or pickup at a brick and mortar store (including a warehouse, fulfillment center, and so on) by the customer. User interface 600 is configured to allow a user to select either or both shipping icon 602 and/or pickup icon 603. For example, in some embodiments, a customer may prefer to pick up one or more items of the order at the store, while also prefer that one or more additional items of the order are shipped to the customer. In some embodiments, only a portion of multiple items in an order may be available for pickup and/or shipping. When a user selects either shipping icon 602 and/or pickup icon 603, system 300 (FIG. 3) coordinates displaying pickup and/or delivery options for each group of items, as described in greater detail below.

Continuing with FIG. 6A, in many embodiments, checkout page 601 displayed on user interface 600 of user computer 340 (FIG. 3) can comprise a first group of items 610 and/or a second or additional group of items 620. Each group of items 610, 620 can comprise one or more items and can be grouped as described in greater detail above.

In many embodiments, checkout page 601 displayed on user interface 600 of user computer 340 (FIG. 3) can further comprise a first delivery date option 611 for first group of items 610. First delivery date option 611 can be displayed responsive to a user selecting shipping icon 602, or can be displayed as an automatic default. First delivery date option 611 can display a date by which first group of items 610 will be delivered to the customer for free (or some other agreed upon shipping price as part of a SLA).

Similarly, in many embodiments, checkout page 601 displayed on user interface 600 of user computer 340 (FIG. 3) can further comprise an additional first delivery date option 621 for additional group of items 620. Additional first delivery date option 621 can be displayed responsive to a user selecting shipping icon 602, or can be displayed as an automatic default. Additional first delivery date option 621 can display a date by which additional group of items 620 will be delivered to the customer for free and also with an order discount applied to the order.

In many embodiments, checkout page 601 displayed on user interface 600 of user computer 340 (FIG. 3) can further comprise an order cost box 650. Order cost box 650 can display a shipping cost 653 and estimated total 651 for the order.

Turning ahead in the drawings to FIG. 6B, in many embodiments, checkout page 601 displayed on user interface 600 of user computer 340 (FIG. 3) can further comprise a dropdown menu 630. Dropdown menu 630 can be displayed responsive to a customer selecting shipping icon 602. In some embodiments, dropdown menu 630 can display a first delivery date option 631 comprising a date by which first group of items 610 will be delivered to the customer for free (or some other agreed upon shipping price as part of a SLA). The cost of shipping by this date also can be displayed in first delivery date option 631 displayed in dropdown menu 630. In some embodiments, dropdown menu 630 also can display a first additional delivery date option 632 comprising a date by which first group of items 610 will be delivered to the customer delivered to the customer for free and also with an order discount applied to the order. The order discount also can be displayed in additional first delivery date option 632 displayed in dropdown menu 630. In some embodiments, dropdown menu 630 can display an expedited delivery date option 633 comprising an earlier date (relative to the first date of the first delivery date option) by which first group of items 610 will be delivered to the customer for an extra cost to the customer. In many embodiments, a customer can select an arrow on dropdown menu 630 to view the shipping and discount options for additional group of items 620.

Turning ahead in the drawings to FIG. 6C, in many embodiments, checkout page 601 displayed on user interface 600 of user computer 340 (FIG. 3) can further comprise a second delivery date option 612 for first group of items 610. Second delivery date option 612 can comprise a second date later than the first date of the SLA. Second delivery date option 612 also can comprise an order discount that will be applied to the order if the customer selects the second delivery date option. In some embodiments, checkout page 601 displayed on user interface 600 of user computer 340 (FIG. 3) can further comprise a faster options icon 613. If a customer selects faster options icon 613 for first group of items 610, system 300 (FIG. 3) coordinates for display faster shipping options for first group of items 610 than first delivery date option 611 and second delivery date option 612. Similarly, in some embodiments, checkout page 601 displayed on user interface 600 of user computer 340 (FIG. 3) can further comprise an additional faster options icon 623. If a customer selects faster options icon 623, system 300 (FIG. 3) coordinates for display faster shipping options for additional group of items 620 than additional first delivery date option 621. By displaying the second or later delivery date option 612 and then showing the customer faster options when requested, an embodiment of a user interface can reduce cognitive load on the customer while at the same time showing the customer relevant information.

Turning ahead in the drawings to FIG. 6D, in many embodiments, checkout page 601 displayed on user interface 600 of user computer 340 (FIG. 3) can further comprise a faster or discount options icon 615. In some embodiments, checkout page 601 can comprise a default view of the only the first delivery date option(s) comprising the delivery date(s) according to a SLA with the customer. System 300 (FIG. 3), can then display faster or discount options icon 615 to allow the customer to view and select a faster shipping option for an increased cost or a slower shipping option for an order discount.

Turning ahead in the drawings to FIG. 6E, in many embodiments, checkout page 601 displayed on user interface 600 of user computer 340 (FIG. 3) can further comprise an expedited delivery date option 614 comprising an earlier date (relative to the first date of first delivery date option 611) by which first group of items 610 will be delivered to the customer for an extra cost to the customer. In some embodiments, expedited delivery date option 614 and/or second delivery date option 612 are displayed responsive to a customer selecting faster or discount options icon 615 (FIG. 6D).

Turning ahead in the drawings to FIG. 6F, if a customer selects second delivery date option 612 (or another delivery date option associated with an order discount calculated as described above), in many embodiments, checkout page 601 displayed on user interface 600 of user computer 340 (FIG. 3) can further comprise shipping cost 653 and shipping savings 652 displayed in order cost box 650. In other embodiments, shipping cost 653 and/or shipping savings 652 can be displayed elsewhere on checkout page 601 or on a later webpage. Shipping savings 652 can comprise a total of order discount(s) if a customer selects one or more delivery options that include delivery of a group of items at a date after the free or SLA date, such as second delivery date option 612. By displaying shipping savings 652 in an area of the user interface where a customer's eyes will be drawn (e.g., near estimated total 651), cognitive load on the customer can be decreased while still providing the customer with information he wants.

Turning ahead in the drawings, FIGS. 6G-6J illustrate various embodiments of order cost box 650 that can be displayed on user interface 600. For example, as illustrated in FIG. 6G, if a customer selects second delivery date option 612 (FIG. 6F) (or another delivery date option associated with an order discount calculated as described above) order cost box 650 can display a subtotal 654 and shipping savings 652. In the same or different embodiments, shipping savings 652 can comprise a selectable user interface element, which is displayed as a question mark enclosed by a circle in FIG. 6G. In various embodiments, a selectable user interface element can comprise other shapes or icons. In some embodiments, when a customer selects a selectable user interface element, additional information can be shown to the customer explaining how shipping savings 652 is calculated. By showing the customer how shipping savings 652 is calculated when a selectable user interface element is selected, an embodiment of a user interface can reduce cognitive load on the customer while at the same time showing the customer relevant information.

As illustrated in FIG. 6H, in some embodiments, if a customer selects a second delivery date option 612 (FIG. 6F) for first group of items 610 and additional first delivery date option 621 (FIG. 6F) for additional group of items 620, order cost box 650 can display subtotal 654, shipping cost 653 that is free, shipping savings 652 that includes an order discount, and estimated total 651.

As illustrated in FIG. 6I, in some embodiments, if a customer selects a second delivery date option 612 for first group of items 610 and an additional expedited delivery date option 621 for additional group of items 620, order cost box 650 can display subtotal 654, shipping cost 653 that includes the extra cost for expedited shipping of additional group of items 620, shipping savings 652 that includes an order discount for first group of items 610, and estimated total 651.

As illustrated in FIG. 6J, in some embodiments, if a customer selects a second delivery date option 612 (FIG. 6F) for first group of items 610, an additional expedited delivery date option 621 (FIG. 6F) for additional group of items 620, and customer pickup for a third group of items, order cost box 650 can display subtotal 654, shipping cost 653 that includes the extra cost for expedited shipping of additional group of items 620, shipping savings 652 that includes an order discount for first group of items 610, a pickup savings 655 that includes a discount to the order for the customer picking up the third group of items at a brick and mortar store, and estimated total 651. In some embodiments, order cost box 650 also can display an associate discount if the customer qualifies for an employee discount with the online retailer.

Turning ahead to FIG. 6K, in some embodiments, checkout page 601 displayed on user interface 600 can comprise a shipping icon and a pickup icon for each group of items. For example, in FIG. 6K, a first shipping icon 601 and a first pickup icon 602 are displayed on user interface 600 proximate first group of items 610. As further shown in FIG. 6K, an embodiment can comprise a second shipping icon 607 and a second pickup icon 608 displayed on user interface 600 proximate second group of items 620. If pickup is not available, a pickup icon can display “pickup not available,” such as shown in second pickup icon 608. Similarly, if shipping is not available, a shipping icon can show “shipping not available.” In some embodiments, first group of items 610 can have a shipping discount 612, and second group of items 620 can have a second shipping discount 622, which can be different than shipping discount 612. In various embodiments, shipping discount 652 can therefore change when one or both of shipping discount 612 and/or second shipping discount 622 are selected. For example, if shipping discount 612 is selected, then the monetary discount for first group of items 610 can be displayed, but, when both shipping discount 612 and second shipping discount 622 are selected, their respective monetary values can be combined and displayed as shipping discount 652. In the same or different embodiments, shipping discount 652 can be greater than an addition of shipping discount 612 and second shipping discount 622 due to the fact that shipping group of items 610 and group of items 620 together can result in additional savings for a retailer.

Turning now to FIG. 7, an exemplary embodiment of a system 700 is shown. In some embodiments, system 700 can comprise an input of an original service level agreement (SLA). In the same or different embodiments, an original SLA can comprise an agreement to deliver an item by a first delivery date option 611 (FIG. 6). In various embodiments, system 700 can comprise a longer SLA. In many embodiments, a longer SLA can comprise an agreement to deliver an item by a second delivery date option 612 (FIG. 6). In the same or different embodiments, system 700 can comprise a single item solution generator. In various embodiments, system 700 can comprise multiple single item solution generators. In various embodiments, a single item solution generator can comprise one or more modules comprising algorithms configured to identify a shipping rate for a single item. In the same or different embodiments, one or more single item solution generators can feed into a multiple item solution generator. In the same or different embodiments, a multiple item solution generator can comprise one or more modules comprising algorithms configured to identify a shipping rate for a group of items. In various embodiments, a multiple item solution generator can determine a best solution shipment structure. In some embodiments, a multiple item solution generator can feed into itself, a second multiple item solution generator, a solver with a non-split option, or a solution consolidator. In the same or different embodiments, a solver with a non-split option can comprise modules including algorithms configured to determine a difference in shipping costs between an original SLA and a longer SLA when an order is shipped as one shipment. In various embodiments, a solution consolidator can comprise modules including algorithms configured to consolidate solutions generated by the multiple item solution generators. In various embodiments, a solution consolidator can comprise modules including algorithms configured to consolidate shipping costs of multiple items when the multiple items are shipped as multiple shipments. In some embodiments, a solution consolidator can create a multiple item solution and forward it to a discount price module. In some embodiments, a discount price module can comprise algorithms configured to determine a discount price and/or a difference in price between an original SLA and a longer SLA.

Although systems and methods for displaying an order discount on a user interface have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
coordinating displaying a set of items of an online retailer on a user interface of a customer electronic device of a customer;
receiving, from the customer electronic device, a first selection by the customer of a first item of the set of items to place the first item in an electronic shopping cart of the customer for a customer order;
determining a first shipping cost to the online retailer for a first delivery of the first item to the customer by a first date from a first shipping location;
determining a second shipping cost to the online retailer for the first delivery of the first item to the customer by a second date from the first shipping location, the second date occurring after the first date and the second shipping cost being less than the first shipping cost;
determining a first order discount for the first item, wherein (1) the first order discount is based at least partially on a difference between the first shipping cost and the second shipping cost, and (2) the first order discount is applied to a first final cost of the first item in the customer order when the customer selects the second date for the first delivery of the first item;
coordinating displaying a checkout page on the user interface of the customer electronic device, the checkout page comprising (1) a first delivery date option comprising the first date for the first delivery of the first item to the customer, (2) a second delivery date option comprising the second date for the first delivery of the first item to the customer, (3) the first order discount that is applied to the first final cost of the first item in the customer order when the customer selects the second delivery date option, and (4) the first order discount that is not applied to the first final cost of the first item in the customer order when the customer selects the first delivery date option, wherein the first final cost does not include the first shipping cost or the second shipping cost;
when the customer selects the second delivery date option, applying the first order discount to the first final cost of the first item when the customer completes the customer order; and
when the customer selects the first delivery date option, not applying the first order discount to the final cost of the first item when the customer completes the customer order.

2. The system of claim 1, wherein:
the one or more non-transitory storage modules storing computing instructions are further configured to run on the one or more processing modules and perform acts of:
receiving, from the user interface of the customer electronic device, a second selection by the customer of a second item of the set of items to place the second item in the electronic shopping cart of the customer for the customer order;
determining a third shipping cost to the online retailer for a second delivery of the second item to the customer by the first date from a second shipping location, the second shipping location being different than the first shipping location;
determining a fourth shipping cost to the online retailer for the second delivery of the second item to the customer by the second date from the second shipping location, the fourth shipping cost being less than the third shipping cost;
determining a second order discount for the second item, wherein (1) the second order discount is based at least partially on a difference between the third shipping cost and the fourth shipping cost, and (2) the second order discount is applied to a second final cost of the second item in the customer order when the customer selects the second date for the second delivery of the second item; and
determining a first group order discount by adding the first order discount and the second order discount;
the checkout page comprises (1) the first delivery date option comprising the first date for (a) the first delivery of the first item to the customer and (b) the second delivery of the second item to the customer, (2) the second delivery date option comprising the second date for (a) the first delivery of the first item to the customer and (b) the second delivery of the second item to the customer, and (3) the first group discount that is applied to (a) the first final cost of the first item in the customer order when the customer selects the second delivery date option comprising the second date for the first delivery of the first item and (b) the second final cost of the second item in the customer order when the customer selects the second delivery date option, and (4) the first group discount that is not applied to (a) the first final cost of the first item in the customer order when the customer selects the second delivery date option comprising the second date for the first delivery of the first item and (b) the second final cost of the second item in the customer order when the customer selects the second delivery date option; and
the one or more non-transitory storage modules storing computing instructions are further configured to run on the one or more processing modules and perform an acts of:
when the customer selects the second delivery date option, applying the second order discount to the second final cost of the second item when the customer completes the customer order; and
when the customer selects the first delivery date option, not applying the second order discount to the second final cost of the second item when the customer completes the customer order.

3. The system of claim 2, wherein the one or more non-transitory storage modules storing the computing instructions are further configured to run on the one or more processing modules and perform acts of:
determining a pro-rated portion of the first group order discount for each of the first item and the second item; and
storing the pro-rated portion of the first group order discount for each of the first item and the second item for use when the customer returns one of the first item or the second item.

4. The system of claim 2, wherein:
the one or more non-transitory storage modules storing the computing instructions are further configured to run on the one or more processing modules and perform acts of:
receiving, from the user interface of the customer electronic device, an additional selection by the customer of an additional item of the set of items to place the additional item in the electronic shopping cart of the customer for the customer order;
determining a fifth shipping cost to the online retailer for an additional delivery of the additional item to the customer by a third date;
determining a sixth shipping cost to the online retailer for the additional delivery of the additional item to the customer by a fourth date after the third date, the sixth shipping cost being less than the fifth shipping cost; and
determining an additional order discount for the additional item, wherein (1) the additional order discount is based at least partially on a difference between the fifth shipping cost and the sixth shipping cost, and (2) the additional order discount is applied to an additional final cost of the additional item in the customer order when the customer selects the fourth date the additional delivery of the additional item;
the checkout page further comprises (1) an additional first delivery date option comprising the third date for the additional delivery of the additional item to the customer, (2) an additional second delivery date option comprising the fourth date for the additional delivery of the additional item to the customer, (3) the additional order discount that is applied to the additional final cost of the additional item in the customer order when the customer selects the additional second delivery date option, and (4) the additional order discount that is not applied to the additional final cost of the additional item in the customer order when the customer selects the additional second delivery date option; and
the one or more non-transitory storage modules storing the computing instructions are further configured to run on the one or more processing modules and perform acts of:
when the customer selects the additional second delivery date option for the additional delivery of the additional item, applying the additional order discount to the additional final cost of the additional item when the customer completes the customer order; and
when the customer selects the additional first delivery date option, not applying the additional order discount to the additional final cost of the additional item when the customer completes the customer order.

5. The system of claim 4, wherein:
the one or more non-transitory storage modules storing the computing instructions are further configured to run on the one or more processing modules and perform acts of:
grouping the first item and the second item into a first group of items based on the first item and the second item being available for delivery on both the first date and the second date; and
grouping the additional item into an additional group of at least one item base on the additional item being available for delivery on the third date but not available for delivery on the first date;
the checkout page comprises:
the first item and the second item as grouped in the first group of items with (1) the first delivery date option comprising the first date, (2) the second delivery date option comprising the second date, and (3) the first group order discount that is applied to the first group when the customer selects the second delivery date option; and
the additional item as grouped in the additional group of at least one item with (1) the additional first delivery date option comprising the third date for the additional delivery of the additional item to the customer, (2) the additional second delivery date option comprising the fourth date for the additional delivery of the additional item to the customer, (3) the additional order discount that is applied to the additional final cost of the additional item in the customer order when the customer selects the additional second delivery date option, and (4) the additional order discount that is not applied to the additional final cost of the additional item in the customer order when the customer selects the additional first delivery date option.

6. The system of claim 1, wherein determining the first order discount for the first item comprises:
determining the difference between the first shipping cost and the second shipping cost; and
multiplying (1) the difference between the first shipping cost and the second shipping cost by (2) a predetermined percentage to determine a shipping savings for the first item.

7. The system of claim 6, wherein determining the first order discount for the first item further comprises:
determining when the shipping savings for the first item exceeds a minimum shipping discount;
determining when the shipping savings for the first item do not exceed a maximum shipping discount;
determining when the shipping savings is less than each of (1) a total price of the first item multiplied by an additional predetermined percentage, and (2) a brick and mortar store pickup discount; and
when (1) the shipping savings for the first item exceeds the minimum shipping discount, (2) the shipping savings do not exceed the maximum shipping discount, and (3) the shipping savings is less than each of (a) the total price of the first item multiplied by the additional predetermined percentage, and (b) the brick and mortar store pickup discount, using the shipping savings as the first order discount.

8. The system of claim 1, wherein coordinating displaying the checkout page on the user interface of the customer electronic device comprises at least one of:
coordinating displaying a dropdown shipping menu on the checkout page on the user interface of the customer electronic device, the dropdown shipping menu comprising (1) the first delivery date option comprising the first date for the first delivery of the first item to the customer and a first customer shipping cost proximate the first delivery date option displayed on the user interface, (2) the second delivery date option comprising the second date for the first delivery of the first item to the customer, and (3) the first order discount proximate the second delivery date option;
coordinating displaying the checkout page on the user interface of the customer electronic device, the checkout page comprising (1) the first delivery date option comprising the first date for the first delivery of the first item to the customer and the first customer shipping cost proximate the first delivery date option displayed on the user interface, (2) a discount icon, wherein when the customer selects the discount icon, coordinating displaying the checkout page on the user interface of the customer electronic device further comprises:
coordinating displaying (a) the second delivery date option comprising the second date for the first delivery of the first item to the customer, and (b) the first order discount that is applied to the first final cost of the first item in the customer order when the customer selects the second delivery date option comprising the second date for the first delivery of the first item to the customer; or
coordinating displaying the checkout page on the user interface of the customer electronic device, the checkout page comprising (1) the first delivery date option comprising the first date for the first delivery of the first item to the customer, (2) the second delivery date option comprising the second date for the first delivery of the first item to the customer, (3) the first order discount that is applied to the first final cost of the first item in the customer order when the customer selects the second delivery date option comprising the second date for the first delivery of the first item to the customer, and (4) when the customer selects the second delivery date option, an order cost box, the order cost box comprising at least a subtotal cost of the first item in the customer order, the first customer shipping cost for the first item, the first order discount, and an estimated total of the subtotal cost added to the first customer shipping cost, less the first order discount.

9. A method being implemented via execution of computing instructions configured to run at one or more processors and configured to be stored at non-transitory computer-readable media, the method comprising:
coordinating displaying a set of items of an online retailer on a user interface of a customer electronic device of a customer;
receiving, from the customer electronic device, a first selection by the customer of a first item of the set of items to place the first item in an electronic shopping cart of the customer for a customer order;
determining a first shipping cost to the online retailer for a first delivery of the first item to the customer by a first date from a first shipping location;
determining a second shipping cost to the online retailer for the first delivery of the first item to the customer by a second date from the first shipping location, the second date occurring after the first date and the second shipping cost being less than the first shipping cost;
determining a first order discount for the first item, wherein (1) the first order discount is based at least partially on a difference between the first shipping cost and the second shipping cost, and (2) the first order discount is applied to a first final cost of the first item in the customer order when the customer selects the second date for the first delivery of the first item;
coordinating displaying a checkout page on the user interface of the customer electronic device, the checkout page comprising (1) a first delivery date option comprising the first date for the first delivery of the first item to the customer, (2) a second delivery date option comprising the second date for the first delivery of the first item to the customer, (3) the first order discount that is applied to the first final cost of the first item in the customer order when the customer selects the second delivery date option, and (4) the first order discount that is not applied to the first final cost of the first item in the customer order when the customer selects the first delivery date option, wherein the first final cost does not include the first shipping cost or the second shipping cost;
when the customer selects the second delivery date option, applying the first order discount to the first final cost of the first item when the customer completes the customer order; and
when the customer selects the first delivery date option, not applying the first order discount to the final cost of the first item when the customer completes the customer order.

10. The method of claim 9, wherein:
the method further comprises:
receiving, from the user interface of the customer electronic device, a second selection by the customer of a second item of the set of items to place the second item in the electronic shopping cart of the customer for the customer order;
determining a third shipping cost to the online retailer for a second delivery of the second item to the customer by the first date from a second shipping location, the second shipping location being different than the first shipping location;
determining a fourth shipping cost to the online retailer for the second delivery of the second item to the customer by the second date from the second shipping location, the fourth shipping cost being less than the third shipping cost;
determining a second order discount for the second item, wherein (1) the second order discount is based at least partially on a difference between the third shipping cost and the fourth shipping cost, and (2) the second order discount is applied to a second final cost of the second item in the customer order when the customer selects the second date for the second delivery of the second item; and
determining a first group order discount by adding the first order discount and the second order discount;
the checkout page comprises (1) the first delivery date option comprising the first date for (a) the first delivery of the first item to the customer and (b) the second delivery of the second item to the customer, (2) the second delivery date option comprising the second date for (a) the first delivery of the first item to the customer and (b) the second delivery of the second item to the customer, and (3) the first group discount that is applied to (a) the first final cost of the first item in the customer order when the customer selects the second delivery date option comprising the second date for the first delivery of the first item and (b) the second final cost of the second item in the customer order when the customer selects the second delivery date option, and (4) the first group discount that is not applied to (a) the first final cost of the first item in the customer order when the customer selects the second delivery date option comprising the second date for the first delivery of the first item and (b) the second final cost of the second item in the customer order when the customer selects the second delivery date option; and
the method further comprises:
when the customer selects the second delivery date option, applying the second order discount to the second final cost of the second item when the customer completes the customer order; and
when the customer selects the first delivery date option, not applying the second order discount to the second final cost of the second item when the customer completes the customer order.

11. The method of claim 10, further comprising:
determining a pro-rated portion of the first group order discount for each of the first item and the second item; and
storing the pro-rated portion of the first group order discount for each of the first item and the second item for use when the customer returns one of the first item or the second item.

12. The method of claim 10, wherein:
the method further comprises:
receiving, from the user interface of the customer electronic device, an additional selection by the customer of an additional item of the set of items to place the additional item in the electronic shopping cart of the customer for the customer order;
determining a fifth shipping cost to the online retailer for an additional delivery of the additional item to the customer by a third date;
determining a sixth shipping cost to the online retailer for the additional delivery of the additional item to the customer by a fourth date after the third date, the sixth shipping cost being less than the fifth shipping cost; and
determining an additional order discount for the additional item, wherein (1) the additional order discount is based at least partially on a difference between the fifth shipping cost and the sixth shipping cost, and (2) the additional order discount is applied to an additional final cost of the additional item in the customer order when the customer selects the fourth date the additional delivery of the additional item;
the checkout page further comprises (1) an additional first delivery date option comprising the third date for the additional delivery of the additional item to the customer, (2) an additional second delivery date option comprising the fourth date for the additional delivery of the additional item to the customer, (3) the additional order discount that is applied to the additional final cost of the additional item in the customer order when the customer selects the additional second delivery date option, and (4) the additional order discount that is not applied to the additional final cost of the additional item in the customer order when the customer selects the additional second delivery date option; and
the method further comprises:
when the customer selects the additional second delivery date option for the additional delivery of the additional item, applying the additional order discount to the additional final cost of the additional item when the customer completes the customer order; and
when the customer selects the additional first delivery date option, not applying the additional order discount to the additional final cost of the additional item when the customer completes the customer order.

13. The method of claim 12, wherein:
the method further comprises:
grouping the first item and the second item into a first group of items based on the first item and the second item being available for delivery on both the first date and the second date; and
grouping the additional item into an additional group of at least one item base on the additional item being available for delivery on the third date but not available for delivery on the first date;
the checkout page comprises:
the first item and the second item as grouped in the first group of items with (1) the first delivery date option comprising the first date, (2) the second delivery date option comprising the second date, and (3) the first group order discount that is applied to the first group when the customer selects the second delivery date option; and
the additional item as grouped in the additional group of at least one item with (1) the additional first delivery date option comprising the third date for the additional delivery of the additional item to the customer, (2) the additional second delivery date option comprising the fourth date for the additional delivery of the additional item to the customer, (3) the additional order discount that is applied to the additional final cost of the additional item in the customer order when the customer selects the additional second delivery date option, and (4) the additional order discount that is not applied to the additional final cost of the additional item in the customer order when the customer selects the additional first delivery date option.

14. The method of claim 9, wherein determining the first order discount for the first item comprises:
determining the difference between the first shipping cost and the second shipping cost; and
multiplying (1) the difference between the first shipping cost and the second shipping cost by (2) a predetermined percentage to determine a shipping savings for the first item.

15. The method of claim 14, wherein determining the first order discount for the first item further comprises:
determining when the shipping savings for the first item exceeds a minimum shipping discount;
determining when the shipping savings for the first item do not exceed a maximum shipping discount;
determining when the shipping savings is less than each of (1) a total price of the first item multiplied by an additional predetermined percentage, and (2) a brick and mortar store pickup discount; and
when (1) the shipping savings for the first item exceeds the minimum shipping discount, (2) the shipping savings do not exceed the maximum shipping discount, and (3) the shipping savings is less than each of (a) the total price of the first item multiplied by the additional predetermined percentage, and (b) the brick and mortar store pickup discount, using the shipping savings as the first order discount.

16. The method of claim 9, wherein coordinating displaying the checkout page on the user interface of the customer electronic device comprises at least one of:
coordinating displaying a dropdown shipping menu on the checkout page on the user interface of the customer electronic device, the dropdown shipping menu comprising (1) the first delivery date option comprising the first date for the first delivery of the first item to the customer and a first customer shipping cost proximate the first delivery date option displayed on the user interface, (2) the second delivery date option comprising the second date for the first delivery of the first item to the customer, and (3) the first order discount proximate the second delivery date option;
coordinating displaying the checkout page on the user interface of the customer electronic device, the checkout page comprising (1) the first delivery date option comprising the first date for the first delivery of the first item to the customer and the first customer shipping cost proximate the first delivery date option displayed on the user interface, (2) a discount icon, wherein when the customer selects the discount icon, coordinating displaying the checkout page on the user interface of the customer electronic device further comprises:
coordinating displaying (a) the second delivery date option comprising the second date for the first delivery of the first item to the customer, and (b) the first order discount that is applied to the first final cost of the first item in the customer order when the customer selects the second delivery date option comprising the second date for the first delivery of the first item to the customer; or
coordinating displaying the checkout page on the user interface of the customer electronic device, the checkout page comprising (1) the first delivery date option comprising the first date for the first delivery of the first item to the customer, (2) the second delivery date option comprising the second date for the first delivery of the first item to the customer, (3) the first order discount that is applied to the first final cost of the first item in the customer order when the customer selects the second delivery date option comprising the second date for the first delivery of the first item to the customer, and (4) when the customer selects the second delivery date option, an order cost box, the order cost box comprising at least a subtotal cost of the first item in the customer order, the first customer shipping cost for the first item, the first order discount, and an estimated total of the subtotal cost added to the first customer shipping cost, less the first order discount.

17. A system comprising:
one or more processing modules; and
one or more non-transitory storage modules storing computing instructions configured to run on the one or more processing modules and perform acts of:
displaying, on a user interface of a customer electronic device of a customer, a set of items of an online retailer;
displaying, on the user interface of the customer electronic device, an electronic shopping cart, the electronic shopping cart comprising at least a first item of the set of items and the first item being selected by the customer in a first selection of a customer order;
displaying, on the user interface of the customer electronic device, a first delivery date option on a checkout page, the first delivery date option comprising a first date for a first delivery of the first item;
displaying, on the user interface of the customer electronic device, a second delivery date option on the checkout page, the second delivery option comprising a second date for the first delivery of the first item, the second date occurring after the first date; and
displaying, on the user interface of the customer electronic device, a first order discount on the checkout page proximate the second delivery date option displayed on the user interface, wherein:
the first order discount is applied to a first final cost of the first item in the customer order when the customer selects the second delivery date option;
the first order discount is not applied to the first final cost of the first item in the customer order when the customer selects the first delivery date option, wherein the first final cost does not include the first shipping cost or the second shipping cost; and
the first order discount is based at least partially on a difference between (1) a first shipping cost to the online retailer for the first delivery of the first item to the customer by the first date from a first shipping location, and (2) the second shipping cost to the online retailer for the first delivery of the first item to the customer by the second date from the first shipping location, the second date being after the first date.

18. The system of claim 17, wherein:
the electronic shopping cart comprises at least the first item of the set of items and a second item of the set of items, the second item of the set of items being selected by the customer in a second selection of the customer order;
displaying the first delivery date option on the checkout page comprises displaying, on the user interface of the customer electronic device, the first delivery date option comprising the first date for (1) the first delivery of the first item to the customer from the first shipping location, and (2) a second delivery of the second item to the customer from a second shipping location;
displaying the second delivery date option on the checkout page comprises displaying, on the user interface of the customer electronic device, the second delivery date option comprising the second date for (1) the first delivery of the first item to the customer from the first shipping location and (2) the second delivery of the second item to the customer from the second shipping location;
displaying the first order discount on the checkout page proximate the second delivery date option comprises displaying, on the user interface of the customer electronic device, a first group order discount combining (1) the first order discount and (2) a second order discount on the checkout page proximate the second delivery date option displayed on the user interface, wherein:
the second order discount is applied to a second final cost of the first item in the customer order when the customer selects the second delivery date option;
the second order discount is not applied to the second final cost of the first item in the customer order when the customer selects the first delivery date option; and
the second order discount is based at least partially on a difference between (1) a third shipping cost to the online retailer for the second delivery of the second item to the customer by the first date from the second shipping location, and (2) a fourth shipping cost to the online retailer for the second delivery of the second item to the customer by the second date from the second shipping location.

19. The system of claim 18, wherein:
the electronic shopping cart comprises at least the first item of the set of items, the second item of the set of items, and an additional item of the set of items, the additional item of the set of items being selected by the customer in an additional selection of the customer order;
the one or more non-transitory storage modules storing the computing instructions are further configured to run on the one or more processing modules and perform acts of:
displaying, on the user interface of the customer electronic device, an additional first delivery date option, the additional first delivery date option comprising a third date for an additional delivery of the additional item;
displaying, on the user interface of the customer electronic device, an additional second delivery date option, the additional second delivery date option comprising a fourth date for the additional delivery of the additional item; and
displaying, on the user interface of the customer electronic device, an additional order discount that is applied to the additional final cost of the additional item in the customer order when the customer selects the additional second delivery date option comprising the fourth date for the additional delivery of the additional item, wherein
the additional order discount is applied to an additional final cost of the additional item in the customer order when the customer selects the additional second delivery date option comprising the fourth date for the additional delivery of the additional item;
the additional order discount is not applied to the additional final cost of the additional item in the customer order when the customer selects the additional first delivery date option comprising the fourth date for the additional delivery of the additional item; and
the additional order discount is based at least partially on a difference between (1) a fifth shipping cost to the online retailer for the additional delivery of the additional item to the customer by the third date, and (2) a sixth shipping cost to the online retailer for the additional delivery of the additional item to the customer by the fourth date.

20. The system of claim 17, wherein displaying the first order discount on the checkout page comprises at least one of:
displaying the first order discount on the checkout page in a dropdown shipping menu, the dropdown shipping menu comprising (1) the first delivery date option comprising the first date for the first delivery of the first item and a first customer shipping cost proximate the first delivery date option, (2) the second delivery date option comprising the second date for the first delivery of the first item, and (3) the first order discount proximate the second delivery date option;
in response to the customer selecting a discount icon displayed on the checkout page, displaying the first order discount that is applied to the first final cost of the first item in the customer order when the customer selects the second delivery date option comprising the second date for the first delivery of the first item to the customer; or
when the customer selects the second delivery date option, displaying an order cost box, the order cost box comprising at least a subtotal cost of the first item in the customer order, the first customer shipping cost for the first item, the first order discount, and an estimated total of the subtotal cost added to the first customer shipping cost, less the first order discount.
